(19) United States
(12) Patent Application Publication
(10) Pub. No.: US 2008/0249765 A1
(43) Pub. Date: Oct. 9, 2008

(54) Audio Signal Decoding Using Complex-Valued Data

(75) Inventor: Erik Gosuinus Petrus Schuijers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,385

(22) PCT Filed: Jan. 13, 2005
(86) PCT No.: PCT/IB2005/050149

§ 371 Date: Jul. 24, 2006

(30) Foreign Application Priority Data
Jan. 28, 2004 (EP) 04100297.3

(51) Int. Cl. G10L 19/02

(52) U.S. Cl. 704/203

(57) ABSTRACT

A decoder particularly, but not exclusively, for MPEG-1 layer III data signals, in which recovered spectral coefficients are transformed into time domain signal components, the time domain signal components then being transformed, using a forward transform which is orthogonally modulated with respect to the forward transform that was used at the encoder, to produce a set of second spectral coefficients. In this way, the first and second spectral coefficients may be used as complex-valued spectral coefficients which are amenable to post-processing. In the preferred embodiment, the complex-valued frequency components are, after post-processing, transformed to the time domain using an odd-frequency modulated Discrete Fourier Transform (DFT).

The present invention relates to audio signal coding. The invention relates particularly, but not exclusively, to decoding MPEG-1 layer III data signals.

MPEG-1 layer III (commonly known as mp3) is a widely used audio codec. The industry standard for mp3 is described in ISO/IEC JTC1/SC29/WG11 MPEG, IS11172-3, Information Technology—Coding of Moving Pictures and Associated Audio for Digital Storage Media at up to about 1.5 Mbit/s, Part 3: Audio, MPEG-1, 1992. This standard is available from the International Organization for Standardization (ISO) (www.iso.ch) and is hereby incorporated herein by way of reference.

The Advanced Audio Coding Standard (AAC) has been devised to address some of the shortfalls of mp3. The AAC standard is described in ISO/IEC JTC1/SC29/WG11 MPEG, IS13818-3, Information Technology—Generic Coding of Moving Pictures and Associated Audio, Part 3: Audio, MPEG-2, 1994, which is also available from ISO.

The respective audio decoder described by each standard creates frequency, or spectral coefficients, i.e. coefficients representing spectral components of a coded data signal, in the form of Modified Discrete Cosine Transform (MDCT) coefficients as part of the decoding process.

Each spectral coefficient represents a respective frequency component of the coded audio signal. In some applications, for example in an equaliser, it would be desirable to be able to perform post-processing on spectral coefficients to allow one or more corresponding frequency components of the signal to be directly manipulated. However, in conventional mp3 and AAC decoding only limited post-processing of the MDCT coefficients is possible. There are two reasons for this. Firstly, the MDCT is a critically sampled and lapped transform (typically employing a 50% overlap) which achieves perfect reconstruction by means of time-domain aliasing cancellation (TDAC). This means that transforming a signal x(n) by means of the (forward) MDCT to X(k) and inverse transforming X(k) to the time domain signal x′(n) by means of the inverse MDCT will in general not give the identity x(n)=x′(n) due to time-domain aliasing. However, perfect reconstruction is achieved by performing overlap-add operations on the signals x′(n). Hence, adjusting MDCT coefficients of a single given frame can affect (e.g. reduce) time-domain aliasing cancellation leading to audible artefacts in the decoded signal. The second reason is that the MDCT is a real-valued transform and this makes phase adjustments, or rotations, practically impossible.

It is known that post-processing may be more readily performed on complex-valued representations of spectral components of a signal, i.e. representations having real and imaginary components. The Spectral Band Replication (SBR) bandwidth extension tool provided by Coding Technologies (www.codingtechnologies.com), e.g., as applied in mp3PRO and Advanced Audio Coding Plus (aacPlus) operates on complex-valued sub-band domain representations.

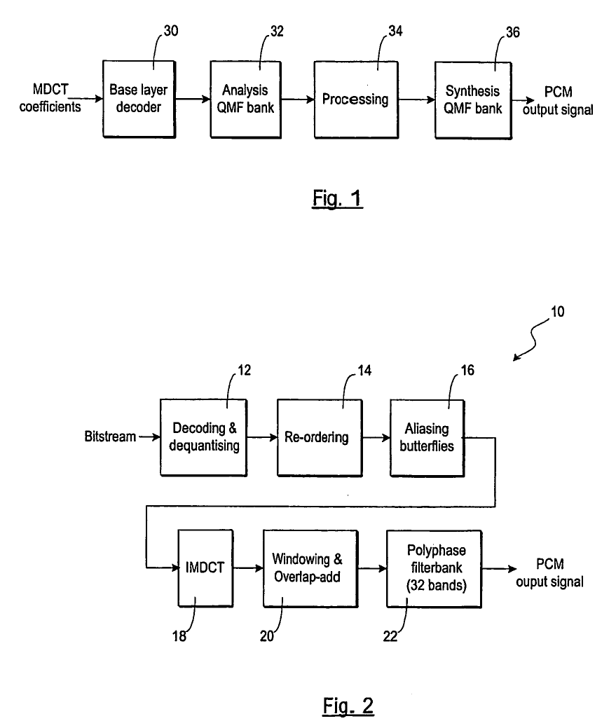

FIG. 1 illustrates an SBR decoder as proposed for AAC. The AAC MDCT coefficients are processed by a full base layer decoder 30 (typically running at half the sampling frequency) to produce a plurality of time domain samples. The time domain samples are provided to a 32 (or 64 where the base layer decoder runs at the full sampling frequency) band complex exponential modulated analysis QMF (Quadrature Mirror Filter) bank 32 to produce complex-valued sub-band domain signals which may be post-processed by a processing unit 34. After post-processing, the complex-valued sub-band domain signals are provided to a 64 band complex exponential modulated synthesis QMF bank 36, which produces an output signal comprising PCM samples. A disadvantage with the algorithm illustrated in FIG. 1 is the need to use complex exponential modulated filterbanks in addition to the base layer decoder, which are expensive both computationally and in terms of memory. The SBR algorithm proposed for mp3 suffers from the same disadvantage.

It would be desirable therefore to provide an audio decoder which supports post-processing of complex-valued spectral coefficients without significantly increasing the complexity of the decoder.

Accordingly, a first aspect of the invention provides a decoder comprising means for recovering a plurality of first spectral coefficients from a received signal, the first spectral coefficients comprising the products of first transform means; inverse transform means for transforming said first spectral coefficients into one or more time domain signal components; second transform means for transforming said one or more time domain signal components into a plurality of second spectral coefficients, wherein, the modulation of said second transform means is orthogonal to the modulation of said first transform means at corresponding modulation frequencies, the decoder further comprising means for processing one or more of said first spectral coefficients in conjunction with a respective second spectral coefficient.

First and second spectral coefficients corresponding to a common modulation frequency may together be treated as a complex valued spectral coefficient and, as such, are suited to post-processing by the processing means.

In a preferred embodiment, one of said first forward frequency transform means and said second forward frequency transform means comprises the Modified Discrete Cosine Transform (MDCT), the other comprising the Modified Discrete Sine Transform (MDST). In such an embodiment, the decoder is particularly suited to decoding mp3 signals. In one embodiment, the decoder includes means for performing complex-valued aliasing reduction on said second spectral coefficients and their respective aliased first spectral coefficients, wherein said complex-valued aliasing reduction means comprises one or more anti-aliasing butterflies arranged to apply complex-valued weights to said aliased first and corresponding second frequency components.

In a preferred embodiment, the decoder further includes means for performing one or more complex-valued inverse frequency transforms on said complex-valued spectral coefficients to produce a plurality of data samples; means for applying one or more types of window functions to said data samples to produce a plurality of windowed data samples; and means for constructing an output signal from said windowed data samples. Preferably, said complex-valued inverse frequency transform comprises an odd-frequency modulated inverse Discrete Fourier Transform (DFT), more preferably an odd-time odd-frequency modulated inverse Discrete Fourier Transform (O²DFT).

Preferably, the decoder further includes means for adjusting the phase of the complex-valued spectral coefficients in accordance with equations [5] and [6] of the following description.

In an alternative embodiment, said inverse transform means comprises a synthesis sub-band filterbank and second forward transform means comprises an analysis sub-band filterbank. Preferably, said first transform means comprises an analysis filterbank, one of said first and second forward transform means being cosine modulated, the other being sine modulated.

A second aspect of the invention provides a method of decoding a data signal, the method comprising recovering a plurality of first spectral coefficients from a received signal, the first spectral coefficients comprising the products of first transform means; transforming, by inverse transform means, said first spectral coefficients into one or more time domain signal components; transforming, by second transform means, said one or more time domain signal components into a plurality of second spectral coefficients, wherein the modulation of said second transform means is orthogonal to the modulation of said first transform means at corresponding modulation frequencies, the method further comprising processing one or more of said first spectral coefficients in conjunction with a respective second spectral coefficient.

Other preferred features are recited in the dependent claims.

Further advantageous aspects of the invention will become apparent to those ordinarily skilled in the art upon review of the following description of a specific embodiment of the invention.

An embodiment of the invention is now described by way of example and with reference to the accompanying drawings in which:

FIG. 1 presents a block diagram illustrating a conventional Spectral Band Replication (SBR) enhanced decoder;

FIG. 2 presents a block diagram of a conventional MPEG-1 layer III decoder;

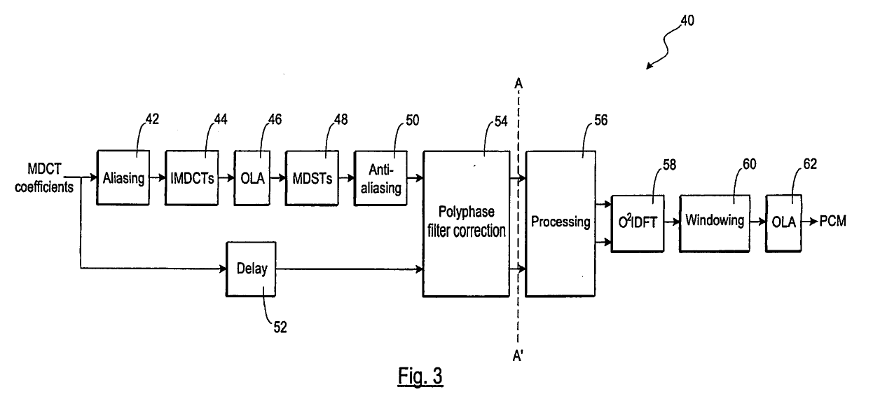

FIG. 3 presents a decoder embodying one aspect of the present invention;

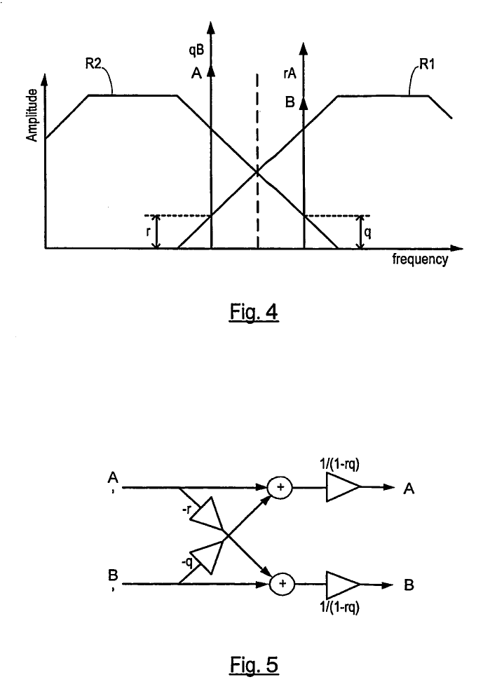

FIG. 4 provides a stylised illustration of the response of two adjacent sub-band filters of a down-sampled filterbank after upsampling;

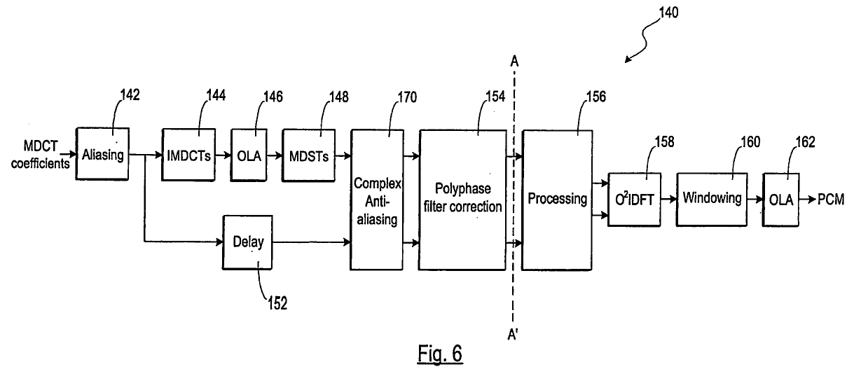

FIG. 5 presents a schematic diagram of an anti-aliasing butterfly;

FIG. 6 presents an alternative embodiment of a decoder embodying one aspect of the invention;

FIG. 7 shows a simplified block diagram of a conventional MPEG-1 layer I/II decoder; and

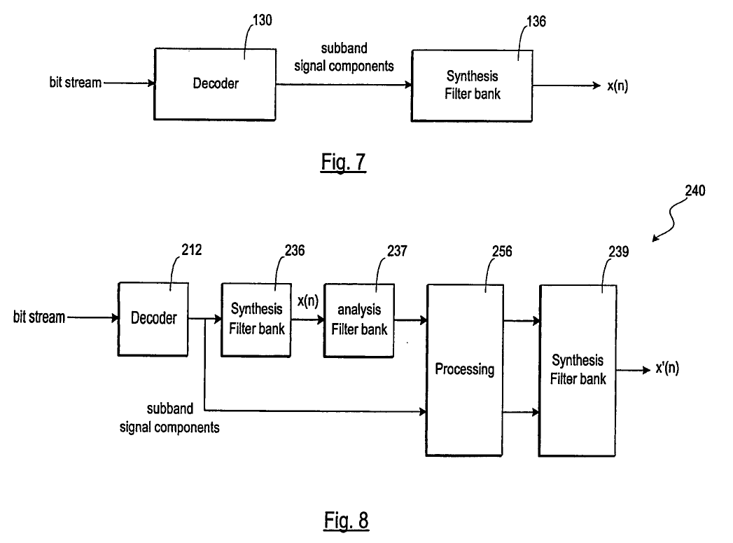

FIG. 8 presents a further alternative embodiment of a decoder embodying one aspect of the invention.

A typical conventional MPEG-1 layer III encoder (not shown) is arranged to receive a PCM input signal comprising a series, or a frame, of 1152 audio input samples. The input signal is supplied to a polyphase analysis filterbank which filters the input signal into 32 uniformly spaced, overlapping frequency bands to produce 32 down-sampled sub-band signal components, each comprising 36 sub-band samples.

In respect of each sub-band signal component, a windowed (forward) MDCT (Modified Discrete Cosine Transform) is performed. Four window types are used to accommodate variable time segmentation. For (quasi-) stationary parts of the signal so-called normal windows can be used, while, for non-stationary parts of the signal, a sequence of so-called short windows can be used. Two transitory types of windows, the so-called start and stop windows, have been defined to prevent discontinuities when switching from normal to short windows and vice versa. For a normal, start or stop window, the MDCT is performed on 36 inputs (i.e. 36 sub-band samples) and produces 18 output MDCT coefficients, which are commonly referred to as frequency lines. For a short window, the MDCT is performed on three sets of 12 inputs (i.e. three sets of 12 sub-band samples) and produces three sets of 6 output MDCT coefficients, or frequency lines. A set of 576 MDCT coefficients is known as a granule. In respect of a typical mp3 frame, which comprises 1152 input samples, two granules are produced as a result of the overlapping nature of the encoding process. In total, 18×32=576 MDCT coefficients, or frequency lines, are produced for each 576 input samples.

In case of normal, start or stop windows, the MDCT frequency lines are provided to anti-aliasing butterflies to reduce the effect of aliasing caused by down sampling the spectrally overlapping filters of the polyphase filterbank. Finally, the MDCT coefficients are coded (using Huffman encoding) and quantized to produce an output signal in a prescribed bitstream format. The quantization and coding is performed under the control of a bit-allocation unit which performs a bit-allocation algorithm, typically steered by a psycho-acoustic model.

FIG. 2 presents a simplified block diagram of a conventional MPEG-1 layer III decoder 10, showing only those components that are helpful for an appreciation of the present invention. The decoder 10 is arranged to receive an input signal in the prescribed mp3 bitstream format. A decoding and dequantizing unit 12 performs decoding (typically Huffman decoding) and dequantization of the bitstream to produce frequency lines, or MDCT coefficients. A respective 576 frequency lines are reproduced for each set of 576 MDCT frequency lines produced by the encoder.

The frequency lines are provided to a re-ordering unit 14, which re-orders the frequency lines, in case of short type of windows, within each granule. In case of normal, start or stop windows, the frequency lines are provided to aliasing butterflies 16 which perform the inverse of the anti-aliasing operation performed by the anti-aliasing butterflies of the encoder.

An IMDCT unit 18 performs IMDCTs (inverse Modified Discrete Cosine Transform) on the frequency lines to produce 32 polyphase filter sub-band signal components each comprising 36 sub-band samples. For those frequency lines corresponding to a normal, start or stop window MDCT, the IMDCT unit 18 takes as input 18 frequency lines and generates 36 sub-band domain samples. For those frequency lines corresponding to a short window MDCT, the IMDCT unit 18 takes as input 3 sets of 6 frequency lines and generates 3 sets of 12 sub-band domain samples.

A windowing operation and standard overlapping and adding operations are performed on the sub-band samples by a windowing and overlap-add unit 20. Information on which type of window to use is carried in the associated side information of the bit stream.

Finally, the sub-band samples are provided to a polyphase synthesis filterbank 22, which performs up sampling by a factor of 32 and produces an output signal comprising PCM samples.

The filterbank 22 comprises a prototype low pass filter that is cosine modulated to form the higher frequency bands. The serial combination of a sub-band filterbank and an MDCT/IMDCT unit is known as a hybrid filterbank, because it partially consists of a filterbank and partially consists of a transform. The IMDCT unit 18 and the synthesis filterbank 22 together comprise a hybrid synthesis filterbank. The use of a hybrid filterbanks is a recognised weakness with mp3 in view of the computational, and therefore implementational, complexity it introduces.

As indicated above, the MDCT coefficients are real-valued (i.e. they do not comprise an imaginary part) and critically sampled and, as such, are not well suited to post-processing. In the following description of a preferred embodiment of the invention, a decoder, having a complexity comparable to the decoder 10, is presented which creates complex-valued coefficients, resembling an oddly-modulated Discrete Fourier Transform (DFT) representation, at an intermediate stage of the decoding process, which are well suited for post-processing. Moreover, the extension of the real-valued MDCT coefficients to the complex-valued coefficients leads to an effective oversampling of a factor of 2. As a result these complex-valued coefficients do not suffer from time-domain-aliasing as with the MDCT. In other words, transforming and inverse transforming a signal x(n) by means of this complex-valued transform and its inverse will lead to the same signal x(n).

The MDCT may be defined as:

$$C ( k ) = {\sum }_{n = 0}^{N - 1} x ( n ) cos ( \frac{2 π ( n + \frac{1}{2} + \frac{N}{4} ) ( k + \frac{1}{2} )}{N} ) \qquad [ 1 ]$$

where n is a time index which, for conventional mp3 decoders, denotes sub-band sample index; N is the transform length or size; k is a frequency index; x(n) is the time domain signal which, in conventional mp3 decoders, comprises the sub-band time domain signal comprised of the sub-band samples; and C(k) is the frequency domain MDCT spectrum.

Equation [1] represents the real part of a complex-valued transform, as shown in equation [2]:

$$C ( k ) = ℜ \{ {\sum }_{n = 0}^{N - 1} x ( n ) {e}^{- j ( \frac{2 π}{N} ( n + \frac{1}{2} + \frac{N}{4} ) ( k + \frac{1}{2} ) )} \} \qquad [ 2 ]$$

The complex-valued transform given in equation [2] is an odd-time odd-frequency Discrete Fourier Transform (O²DFT) and may be efficiently computed by pre- and post-rotation (or modulation) of a Fast Fourier Transform (FFT). A transform known as the Modified Discrete Sine Transform (MDST) is provided by the imaginary part of the complex-valued transform of equation [2]. Hence, the MDST may be described as follows:

$$S ( k ) = - \{ {\sum }_{n = 0}^{N - 1} x ( n ) {e}^{- f ( \frac{2 π}{N} ( n + \frac{1}{2} + \frac{N}{4} ) ( k + \frac{1}{2} ) )} \} \qquad [ 3 ]$$

where S(k) is the frequency domain MDST spectrum.

Hence, MDCT coefficients together with their corresponding MDST coefficients provide a complex-valued representation of a data signal in the frequency domain, each MDCT coefficient providing the real part of a respective complex-valued coefficient while the corresponding MDST provides the imaginary part. Such complex-valued coefficients are well suited to post-processing. The MDCT and the MDST may be said to be mutually orthogonal transforms, i.e. transforms that are orthogonal with respect to each other, in that the transform kernel for frequency index k of one transform is orthogonal to the transform kernel of the other transform for that same frequency index k. In other words, the respective transform modulation kernels of the first transform (e.g. the MDCT) and of the second transform (e.g. the MDST) which have the same modulation frequency is orthogonal.

It is this orthogonal property that allows the respective outputs of the transforms to be used as corresponding real and imaginary parts of a complex-valued valued representation. In general, the modulation of the forward frequency transform used in decoders embodying the invention to create the imaginary parts of the complex-valued frequency, or spectral, coefficients is orthogonal, at corresponding frequencies, to the modulation of the forward frequency transform used in the encoder to create the real parts of the complex-valued frequency, or spectral, coefficients (or vice versa, i.e. where the forward frequency transform in the decoder creates the real part and the forward frequency transform in the encoder creates the imaginary parts of the complex-valued frequency coefficients). In the following description of a specific embodiment of the invention, it is assumed that the decoder is arranged to decode mp3 data signals and so the MDCT is employed in the encoder (not illustrated) and the MDST is employed in the decoder embodying the invention. It will be understood, however, that in alternative embodiments, other similarly orthogonal transforms may be employed. Moreover, other means for converting data signals from the time domain to the frequency domain (and vice versa) may be used, e.g. sub-band analysis and synthesis filterbanks, which are modulated in a mutually orthogonal manner.

FIG. 3 presents a block diagram of a decoder 40 embodying one aspect of the present invention. For clarity, only those components of the decoder 40 that are helpful for understanding the invention are shown. The decoder 40 is arranged to operate on a plurality of MDCT coefficients or frequency lines, as indicated at the left hand side of FIG. 3. Normally, the MDCT coefficients are recovered by decoding and dequantizing an input signal received by the decoder 40. For example, in the case where the decoder 40 comprises an mp3 decoder, the input signal comprises an mp3 encoded bitstream and the decoder 40 further includes a decoding and dequantization unit and a re-ordering unit (as shown in FIG. 2 but not shown in FIG. 3) which recover and re-order the received mp3 bitstream to produce the MDCT coefficients. In the following description, it is assumed, by way of example, that the decoder 40 is arranged for decoding mp3 signals.

In order to obtain the sub-band domain samples, the MDCT coefficients are transformed by means of an IMDCT. For mp3 decoding, this may be achieved in the same manner as employed by the conventional mp3 decoder 10. Hence, in the preferred embodiment, the decoder 40 includes an aliasing unit, or aliasing butterflies 42, and an IMDCT unit 44 which are analogous to, respectively, the aliasing butterflies 16 and the IMDCT unit 18 of the conventional decoder 10.

The IMDCT unit 44 produces a plurality sub-band domain signal components comprising sub-band samples. Conventional windowing and overlap-add operations are performed on the sub-band samples by a windowing and overlap-add unit 46 which, in the preferred embodiment, is analogous to the windowing and overlap-add unit 20 of the conventional decoder 10.

In order to generate complex-valued coefficients, the decoder 40 must create the imaginary parts of the coefficients. As described above with reference to equation [3], this may be achieved by performing MDSTs on the sub-band domain signal components. After the overlap-add operations, the sub-band signal components are ready to be transformed back to the frequency domain and are provided to an MDST unit 48.

In respect of each sub-band domain signal component, the MDST unit 48 performs a windowed (forward) MDST. For a normal, start or stop window, the MDST is performed on 36 inputs (i.e. 36 sub-band samples) and produces 18 output MDST coefficients, or frequency lines. For a short window, the MDST is performed on three sets of 12 inputs (i.e. three sets of 12 sub-band samples) and produces three sets of 6 output MDST coefficients.

It is preferred to perform anti-aliasing on the MDST coefficients. Hence the decoder 40 preferably includes an anti-aliasing unit 50, or anti-aliasing butterflies. Normally, anti-aliasing is performed only in respect of data associated with normal, start or stop windows. The anti-aliasing butterflies 50 are generally similar to the anti-aliasing butterflies described in the mp3 standard except that some aspects of the computation are negated. Specifically, with reference to the mp3 standard and using the same notation, for use in anti-aliasing butterflies for MDCT coefficients, a vector c is defined:

c=[−0.6,−0.535,−0.33,−0.185,−0.095,−0.041,−0.0142,−0.0037]

from which two further vectors cₐ and cₛ may be calculated as follows:

$${c}_{a} ( k ) = \frac{c ( k )}{\sqrt{1 + {c ( k )}^{2}}} k = 0 , … , 7 \\ {c}_{s} ( k ) = \frac{1}{\sqrt{1 + {c ( k )}^{2}}} k = 0 , … , 7 \qquad [ 4 ]$$

When performing anti-aliasing on MDST coefficients, the vector cₐ is negated, i.e. multiplied by a factor of −1. Otherwise, the anti-aliasing butterflies 50 may operate in accordance with the mp3 standard.

Hence, at the decoding stage represented by broken line AA′ in FIG. 3, complex-valued coefficients are available to the decoder 40, the imaginary part of each coefficient being provided by a respective MDST coefficient, the real part of the coefficient being provided by the corresponding MDCT coefficient. In order to synchronise the production of each MDST coefficient with its respective MDCT coefficient, the MDCT coefficients are preferably delayed by a delay element 52. The amount of delay depends on the processing delay needed to produce the MDST coefficients which is primarily determined by the delay required to perform the overlap-add operations. The decoder 40 produces a respective complex-valued coefficient for each MDCT coefficient of each granule.

The complex-valued coefficients are suitable for post-processing and, to this end, a processing unit 56 is provided in the decoder 40 for adjusting one or more of the complex-valued coefficients as desired. Since the complex-valued coefficients are frequency domain components, post-processing may advantageously be performed directly on one or more frequency components of the coded signal.

The decoder 40 is also required to generate a time domain output signal comprising, in the present example, a PCM signal from the post-processed (as applicable) complex-valued coefficients. To this end, it is observed that the form of the complex-valued coefficients is similar to the form of coefficients produced by an O²DFT. Furthermore, the coefficients obtained by the whole frequency analysis (in both the encoder and decoder) in combination with the anti-aliasing (in both the encoder and decoder) correspond very well to those obtained by a single complex-valued transform, rather than a set of complex-valued transforms on each sub-band signal. It is supposed, therefore, that it is possible to generate a time domain output signal by performing an inverse O²DFT on the complex-valued coefficients. This advantageously obviates the need to use a sub-band filterbank in the decoder 40.

However, in order to reduce perceptible artefacts in the output signal, it is preferred to perform some pre-processing of the complex-valued coefficients so that they more closely resemble O²DFT coefficients, as would have been obtained by a single O²DFT rather than O²DFTs on each sub-band signal. In this connection, the main differences between the complex-valued coefficients generated by the decoder 40 and true O²DFT coefficients are: 1) although largely reduced by the anti-aliasing performed by the anti-aliasing butterflies 50 and in the encoder, some aliasing is still present in the complex-valued coefficients; and 2) phase rotation caused by the (polyphase) filterbank of conventional mp3 encoders.

The residual aliasing is not significant and may be tolerated. However, the phase rotation caused by the polyphase filter can be compensated for by applying a phase rotation, or shift, to each complex-valued coefficient. The respective phase characteristics of both the hybrid mp3 filterbank and an O²DFT are substantially linear and may therefore be represented by a linear function. The mp3 filterbank in combination with applying frequency inversion to the odd sub-bands also negates alternate sub-bands (i.e. introduces a phase shift of 180° or π). Hence, the phase shift φ_{comp} required by the complex-valued coefficients to compensate for the behaviour of an mp3, or similar, filterbank may be approximated by:

$${ϕ}_{cump} ( k ) = ak + b + π mod ( ⌊ \frac{k}{18} ⌋ , 2 ) , k = 0 , … , 575 \qquad [ 5 ]$$

where a and b are constants and k is an index corresponding to the 576 coefficients of a granule. The term ak+b provides a linear phase shift associated with the linear phase characteristics of both prototype filter and the applied cosine modulation while the term πmod(└k/18┘2) serves to negate coefficients corresponding to alternate sub-bands (assuming a normal mp3 structure). The values of a and b may be determined by measuring the phase characteristic of an arbitrary input signal at the output of an O²DFT and at the output of a hybrid complex-extended MPEG-1 analysis filterbank. By analyzing these respective phase characteristics for a plurality of input signals, or frames, the values of a and b can be optimized.

Polyphase filter correction can thus be applied to the complex-valued coefficients as a straightforward rotation:

P_{corr}(k)=exp(j·φ_{comp}(k))P(k) [6]

where P(k) are the uncompensated complex-valued coefficients and P_{corr}(k) are the compensated, or corrected, complex-valued coefficients (available at stage AA′ in FIG. 3).

In FIG. 3, the decoder 40 includes a phase compensation unit 54, or polyphase filter correction unit, for performing the phase compensation of equation [6]. The phase compensation unit 54 provides the compensated complex-valued coefficients P_{corr}(k) to the processing unit 56.

After post-processing (as applicable), the complex-valued coefficients are ready to be transformed to the time domain. As indicated above, this is conveniently achieved by performing one or more inverse O²DFT on the complex-valued coefficients associated with each granule. To this end, the decoder 40 further includes an inverse O²DFT unit 58, provided for performing one or more inverse O²DFTs on the complex-valued coefficients. It will be seen that, in the preferred embodiment, the inverse O²DFT unit 58 is arranged to operate on the respective complex-valued coefficients of a whole granule at a time, rather than applying a series of smaller inverse O²DFTs to complex-valued coefficients in accordance with which sub-band they are associated. Hence the inverse O²DFT unit 58 performs either a single inverse O²DFT on all complex-valued coefficients associated with a granule (when normal, start or stop type windows are required) or a plurality inverse O²DFTs on a corresponding number of sub-sets of all the complex-valued coefficients associated with the granule (when short type windows are required). For an mp3 bitstream where a granule comprises 576 frequency lines, the inverse O²DFT unit 58 performs a single inverse O²DFT on the whole granule for normal, start or stop windows resulting in 1152 time domain samples, and three inverse O²DFTs on a respective one of 3 sub-sets of 192 complex-valued coefficients, resulting in three respective sequences, or sets, of 384 time domain samples. The output of the inverse O²DFT unit 58 comprises a plurality (1152 in the present example) of recovered signal components, or samples, which may be used to construct a PCM output signal.

In order to construct the PCM output signal, windowing and overlap-add operations are performed on the signal samples produced by the inverse O²DFT unit 58. Hence, the decoder 40 further includes a windowing unit 60 and an overlap-add unit 62, the operation of which are described in more detail below.

In order that the construction of the PCM output signal using the windowing and overlap-add units 60, 62 may be better understood, conventional mp3 windowing is now described in more detail. Within mp3 four different window types (and accompanying lengths) are prescribed, namely ‘normal’, ‘start’, ‘short’ and ‘stop’. A particular type of window, or sequence of different window types, is selected to suit the characteristics of the portion of the data to which the window(s) are to be applied. For example, short type windows are usually applied to data portions corresponding to transients in the audio signal. The side information associated with a given data frame indicates which window types are to be used with the granule. The required window type affects both the length, or size, of the MDCT (and therefore inverse MDCT) and the windowing/overlap-add operations.

For mp3, the window functions z(n) may be described as follows:

For a normal type of window (type 0):

$$z ( n ) = sin ( \frac{π}{36} ( n + \frac{1}{2} ) ) n = 0 … 35 \qquad [ 7 ]$$

For a start type of window (type 1):

$$z ( n ) = \{ \begin{matrix}sin ( \frac{π}{36} ( n + \frac{1}{2} ) ) & n = 0 … 17 \\ 1 & n = 18 … 23 \\ sin ( \frac{π}{12} ( n + \frac{1}{2} - 18 ) ) & n = 24 … 29 \\ 0 & n = 30 … 35\end{matrix} \qquad [ 8 ]$$

For short type of windows (type 2), three short windows are coded simultaneously:

$${z}_{p} ( n ) = sin ( \frac{π}{12} ( n + \frac{1}{2} ) ) n = 0 … 11 , p = 0 , 1 , 2 \qquad [ 9 ]$$

For a stop type of window (type 3):

$$z ( n ) = \{ \begin{matrix}0 & n = 0 … 5 \\ sin ( \frac{π}{12} ( n + \frac{1}{2} - 6 ) ) & n = 6 … 11 \\ 1 & n = 12 … 17 \\ sin ( \frac{π}{36} ( n + \frac{1}{2} ) ) & n = 18 … 35\end{matrix} \qquad [ 10 ]$$

Each of the window functions in equations [7], [8], [9] and [10] are normally regarded as single window functions even though they may involve the application of more than one window. It will be seen from functions [7], [8], and [10] that the window length is 36 (i.e. a 36 point window) and hence index n runs from 0 to 35. For function [9], the combined length of the three short 12 point windows is 36 and hence n runs from 0 to 11 for p=0 to 2. Thus, the overall length of each window type corresponds to the size of a sub-band signal component (36 sub-band samples).

The construction of the PCM output signal by the windowing and overlap-add units 60, 62 in conjunction with the inverse O²DFT unit 58 is now described. It is assumed in the following example that the original PCM signal comprises frames of 1152 audio samples, each frame being effectively transformed into two granules of 576 frequency lines (or MDCT coefficients). Hence, the inverse O²DFT unit 58 operates on granules of 576 complex-valued coefficients to produce a signal comprising 1152 samples which are then provided to the windowing and overlap-add units 60, 62. It will be seen that only the respective real parts of the signal samples produced by the inverse O²DFT unit 58 are provided to the windowing unit 60.

The l^{th} set, or granule, of complex-valued coefficients is denoted as Xₗ(k) where k=0 . . . 575. With reference to FIG. 3, Xₗ(k) is comprised of a respective set or granule of corrected complex-valued coefficients P_{corr}(k) (after post-processing by the processing unit 56). The output signal produced by the windowing and overlap-add units 60, 62 after decoding the l^{th} set (l starting at 0) of complex-valued coefficients is described as (using overlap-add):

yₗ₊₁(n+576·l)=yₗ(n+576·l)+xₗ₊₁(n) [11]

where index n=0 . . . 1151, yₗ(n) is the output signal after decoding the l^{th} set and xₗ(n) is real part of the signal resulting from transforming (by inverse O²DFT) the complex-valued coefficients Xₗ(k). The output signal y₀(n) is initialised to zero for all n.

The generation of the signal xₗ(n) is dependent on the corresponding specified window type as follows. In case the window type of the l^{th} set is 0, 1, or 3, the inverse O²DFT unit 58 generates a temporary signal xₜₘₚ(n) comprising the real part of the inverse O²DFT with input length 576 and output length 1152 (i.e. a single “long” inverse O²DFT on all complex-valued coefficients associated with a respective granule). An appropriate transform is given in equation [12]:

$${x}_{tmp} ( n ) = \frac{2}{N} ℜ \{ {\sum }_{k = 0}^{N / 2 - 1} {X}_{l} ( k ) exp ( j \frac{2 π}{N} ( n + \frac{1}{2} + \frac{N}{4} ) ( k + \frac{1}{2} ) ) \} \qquad [ 12 ]$$

with n=0 . . . N−1 and the transform length N=1152.

When the window type for the l^{th} set is 2 (i.e. a “short window”), the inverse O²DFT unit 58 performs a respective inverse O²DFT on three sets of 192 complex-valued coefficients to produce three respective temporary signals denoted as x_{tmp,0}(n), x_{tmp,1}(n) and x_{tmp,2}(n) of 384 points each, as shown in equation [13]:

$${x}_{tmp , p} ( n ) = \frac{2}{N} ℜ \{ {\sum }_{k = 0}^{N / 2 - 1} {X}_{l} ( k + 192 \cdot p ) exp ( j \frac{2 π}{N} ( n + \frac{1}{2} + \frac{N}{4} ) ( k + \frac{1}{2} ) ) \} , \qquad [ 13 ]$$

where index p=0 . . . 2, n=0 . . . N−1, N=384 and Xₗ(k) is sorted according to p prior to sorting in frequency.

It is the temporary signals xₜₘₚ(n), x_{tmp,p}(n) that are effectively provided to the windowing and overlap-add units 60, 62.

When the window type of the l^{th} set is 0, the signal xₗ(n) is calculated by the windowing unit 60 as:

$${x}_{l} ( n ) = sin ( \frac{π}{1152} ( n + \frac{1}{2} ) ) {x}_{tmp} ( n ) n = 0 … 1151 \qquad [ 14 ]$$

where the divisor 1152 in [14] corresponds with the inverse O²DFT transform length N.

When the window type of the l^{th} set is 1, the signal xₗ(n) is calculated by the windowing unit 60 as:

$$\begin{matrix}{x}_{l} ( n ) = sin ( \frac{π}{1152} ( n + \frac{1}{2} ) ) {x}_{tmp} ( n ) & n = 0 … 575 \\ {x}_{l} ( n ) = {x}_{tmp} ( n ) & n = 576 … 767 \\ {x}_{l} ( n ) = sin ( \frac{π}{384} ( n + \frac{1}{2} - 576 ) ) {x}_{tmp} ( n ) & n = 768 … 959 \\ {x}_{l} ( n ) = 0 & n = 960 … 1151\end{matrix} \qquad [ 15 ]$$

When the window type of the l^{th} set is 2, the windowing unit 60 calculates the signal xₗ(n) by first calculating three temporary signals:

$${x}_{l , tmp , p} ( n ) = sin ( \frac{π}{384} ( n + \frac{1}{2} ) ) {x}_{tmp , p} ( n ) \\ n = 0 … 383 , p = 0 … 2 \qquad [ 16 ]$$

where the divisor 384 in [16] corresponds with the inverse O²DFT transform length N.

The signal xₗ(n) is then constructed as follows:

$$\begin{matrix}{x}_{l} ( n ) = 0 & n = 0 … 191 \\ {x}_{l} ( n ) = {x}_{l , tmp , 0} ( n - 192 ) & n = 192 … 383 \\ {x}_{l} ( n ) = {x}_{l , tmp , 0} ( n - 192 ) + {x}_{l , tmp , 1} ( n - 384 ) & n = 384 … 575 \\ {x}_{l} ( n ) = {x}_{l , tmp , 1} ( n - 384 ) + {x}_{l , tmp , 2} ( n - 576 ) & n = 576 … 767 \\ {x}_{l} ( n ) = {x}_{i , tmp , 2} ( n - 576 ) & n = 768 … 959 \\ {x}_{l} ( n ) = 0 & n = 960 … 1151\end{matrix} \qquad [ 17 ]$$

When the window type of the l^{th} set is 3, the windowing unit 60 calculates the signal xₗ(n) as:

$$\begin{matrix}{x}_{l} ( n ) = 0 & n = 0 … 191 \\ {x}_{l} ( n ) = sin ( \frac{π}{384} ( n + \frac{1}{2} - 192 ) ) {x}_{tmp} ( n ) & n = 192 … 383 \\ {x}_{l} ( n ) = {x}_{tmp} ( n ) & n = 384 … 575 \\ {x}_{l} ( n ) sin ( \frac{π}{1152} ( n + \frac{1}{2} ) ) {x}_{tmp} ( n ) & n = 576 … 1151\end{matrix} \qquad [ 18 ]$$

where the divisor 1152 corresponds with the inverse O²DFT transform length N and the divisor 384 corresponds with N/3.

It will be seen that equations [14], [15], [16] and [18] are of the general type:

xₗ(n)=z(n)xₜₘₚ(n) [19]

where xₗ(n) is the windowed signal, xₜₘₚ(n) is the unwindowed signal and z(n) is the window function. It is noted that the window functions z(n) of equations [14], [15], [16] and [18] are generally similar to the window functions z(n) described in equations [7], [8], [9] and [10] respectively. However, the respective window lengths of the window functions z(n) in equations [14], [15], [16] and [18] are longer in accordance with the respective transform length N and the respective divisors are correspondingly larger. The window functions z(n) of equations [14], [15], [16] and [18] may be said to comprise up-sampled versions of the window functions z(n) described in equations [7], [8], [9] and [10] respectively, the extent of the up sampling depending on the respective transform length/window length, N. It will also be noted that the window functions of equations [14], [15], [16] and [18] each comprises a single window function even though its application may involve the application of more than one window.

It will be appreciated from the foregoing description that the decoder 40 allows post-processing of the coded signal at an intermediate stage of the decoding process by creating complex-valued coefficients. Advantageously, since the complex-valued coefficients are representative of frequency or spectral components of the coded signal, frequency based post-processing can be performed directly. Moreover, the decoder 40 is not significantly more complex-valued than the conventional mp3 decoder 10 and, advantageously, does not require a synthesis filterbank. It is also noted that the decoder 40 does not suffer from time domain aliasing as the O²DFT representation is effectively oversampled by a factor of 2.

In the foregoing embodiment, one or more inverse O²DFT is applied to the complex-valued coefficients. In alternative embodiments, alternative transforms may be used. For example, in cases where an odd-frequency modulated transform, e.g. an odd-frequency modulated Discrete Cosine Transform (DCT), i.e, DCT Type IV, is used at the encoder, a corresponding inverse odd-frequency modulated transform, e.g. an odd-frequency modulated DFT, is used in the decoder. Hence, in the decoder 40, an odd-frequency modulated inverse discrete Fourier transform may be used in place of the inverse O²DFT. With reference in particular to equations [12] and [13], the odd-frequency modulation, or rotation, is represented by the term (k+½), wherein the 1/2 shifts the transform sampling in the frequency domain by half a sample. An odd frequency modulated discrete Fourier transform may be defined as follows:

$$C ( k ) = {\sum }_{n} x ( n ) {e}^{- j ( \frac{2 π}{N} ( n + φ ) ( k + \frac{1}{2} ) )}$$

where, φ may take an arbitrary value.

It is not essential that odd-frequency modulated transforms are used. For example, an evenly-frequency modulated transform (e.g. a DCT type I transform) may be used at the encoder provided a similarly modulated inverse transform is used at the decoder. Other frequency modulations (kernels) may be used provided compatible modulation kernels are used at the encoder and the decoder.

In an alternative embodiment (not illustrated), the inverse O²DFT unit is arranged to apply a series of smaller inverse O²DFTs to complex-valued coefficients in accordance with which sub-band they are associated, rather than operating on the respective complex-valued coefficients of a whole granule at a time. Hence, in the case of mp3 coefficients, the inverse O²DFT unit produces 32 complex-valued sub-band domain signal components each comprising 36 sub-band samples. For those complex-valued coefficients corresponding to a normal, start or stop window, the inverse O²DFT unit takes as input 18 complex-valued coefficients and generates 36 complex-valued sub-band domain samples. For those complex-valued coefficients corresponding to a short window, the inverse O²DFT unit takes as input 3 sets of 6 complex-valued coefficients and generates 3 sets of 12 complex-valued sub-band domain samples. In such an embodiment, it is preferred to include an aliasing unit between the post-processing unit and the inverse O²DFT unit for performing aliasing on the complex-valued coefficients to counteract, or substantially counteract, the anti-aliasing provided by the anti-aliasing unit 50 and the anti-aliasing in the encoder. After the inverse O²DFT unit, the complex-valued sub-band samples are then provided to a complex exponential modulated synthesis filterbank of which only the real-valued output components are used to provide the output signal of the decoder. By way of example, a complex exponential modulated synthesis filterbank may be implemented using similar equations as a conventional cosine modulated filterbank but with the cosine function replaced by an equivalent complex exponential function. Moreover, because only the real-valued output is used, one option is to employ a conventional cosine modulated filterbank on the real-valued parts of the complex-valued sub-band samples and to employ a corresponding sine modulated filterbank (which uses the same equations as a cosine modulated filterbank but with the cosine modulation replaced by a sine modulation) on the imaginary part of the complex-valued sub-band samples.

In the decoder 40 of FIG. 3, the anti-aliasing unit 50 may comprise conventional anti-aliasing means typically in the form of conventional anti-aliasing butterflies. Such butterflies apply a weighted summation using real values to weight coefficients. Examples of such anti-aliasing butterflies are described in U.S. Pat. No. 5,559,834 (Edler) and in B. Edler, “Aliasing reduction in sub-bands of cascaded filter banks with decimation”, Electronics Letters, Vol. 28, No. 12, pp. 1104-1106, 4 Jun. 1992. Such butterflies reduce the aliasing caused by the critical down sampling of a polyphase filter bank.

By way of illustration, FIG. 4 shows a stylised response R1, R2 of first and second adjacent sub-band filters (not shown) of a down-sampled polyphase filterbank after up sampling. Also shown are two spectral components with values A and B obtained by, for example, applying an MDCT to the respective sub-band signal associated with the sub-band filters. It will be seen that, as a result of aliasing, there is an additional spectral component with value qB at the frequency corresponding to spectral component with value A, and an additional spectral component with value rA at the frequency corresponding to spectral component with value B. Hence, due to down sampling, the value of the spectral component at the frequency corresponding to spectral component with value A may be given as A+qB, while the value of the spectral component at the frequency corresponding to spectral component with value B may be given as B+rA. The respective values of q and r are determined by the respective transfer functions of the respective sub-band filters at the respective frequencies of spectral components with values B and A. The actual value of the spectral components with value A and B can be calculated as follows:

$$\begin{matrix}{A}^{′} = A + qB & {B}^{′} = B + rA \\ A = {A}^{′} - q ( {B}^{′} - rA ) & B = {B}^{′} - r ( {A}^{′} - qB ) \\ A = \frac{{A}^{′} - {qB}^{′}}{1 - rq} & B = \frac{{B}^{′} - {rA}^{′}}{1 - rq}\end{matrix} \qquad [ 20 ]$$

where A, A′ B and B′ represent respective spectral component values, or amplitudes. The equations [20] may be represented diagrammatically in the form of an anti-aliasing butterfly as shown in FIG. 5. Conventionally, the values for r and q are real values (i.e. they do not comprise a complex-valued component).

Using real values allows anti-aliasing butterflies to compensate for the effects of aliasing on the amplitude of spectral coefficients in cases where the phase difference between a spectral component (e.g A+qB in FIG. 4) and the corresponding mirrored spectral component (e.g. B+rA in FIG. 4) is approximately 180° (or π) or a multiple thereof. As a result, real-valued anti-aliasing butterflies are particularly suitable for processing MDCT or MDST coefficients (obtained from the sub-band domain samples of an analysis filterbank) in respect of which normal, start or stop type windows are specified. However, where short type windows are specified, the phase difference between mirroring spectral components cannot adequately be approximated by multiples of π near the sub-band border. Hence, the conventional anti-aliasing unit 50 is only useful in cases where normal, start and stop windows apply. As such, within the mp3 standard anti-aliasing is only applied to these types of windows.

An alternative embodiment of the invention is now described with reference to FIG. 6 which mitigates the problem outlined above by using complex-valued anti-aliasing butterflies. FIG. 6 presents a block diagram of a decoder 140 that employs complex-valued anti-aliasing butterflies. Referring now to FIG. 6, the decoder 140 is generally similar to the decoder 40 and like numerals are used to indicate like components. However, the decoder 140 includes a complex-valued anti-aliasing unit 170 arranged to perform anti-aliasing on complex-valued coefficients by applying complex-valued weights, or multipliers, to the complex-valued coefficients. The anti-aliasing unit 170 may comprise anti-aliasing butterflies of the general type shown in FIG. 4 in which the values for the weights, or multipliers, r and q are complex-valued. The real part of each complex-valued coefficient provided to the complex-valued anti-aliasing unit 170 comprises a respective MDCT coefficient delayed appropriately by the delay unit 152, and the imaginary part of the complex-valued coefficient comprises the corresponding MDST coefficient, or quadrature component, provided by the MDST unit 148. In contrast with the decoder 40, conventional aliasing is performed on the MDCT coefficients (conveniently by aliasing unit 142) that are subsequently used to provide the real part of the complex-valued coefficients.

After complex-valued anti-aliasing has been performed on the complex-valued coefficients, they are provided to the polyphase filter correction unit 154. Further processing of the coefficients is as described with reference to FIG. 3.

Suitable complex values for the weights r and q may be determined experimentally. For example, to provide a first estimation for r and q, a respective sinusoidal signal of known amplitude is supplied to a conventional mp3 hybrid filterbank (not shown) of the type normally found in an mp3 encoder (i.e. comprising a polyphase analysis filterbank and means for performing MDCTs on the sub-band signals produced by the analysis filterbank) in respect of each MDCT frequency bin. The respective frequency of the each sinusoidal signal is selected as the centre frequency of the respective MDCT frequency bin. For normal, start and stop windows, the centre frequency can be calculated as:

$$f = ( k + \frac{1}{2} ) \frac{{f}_{s}}{1152} Hz \qquad [ 21 ]$$

where k=0 . . . 575, fₛ is the sampling frequency and the divisor 1152 corresponds with the transform length N. Hence 576 frequencies are calculated from equation [21], one for each MDCT bin.
For the short type windows, the centre frequencies can be calculated as:

$$f = ( k + \frac{1}{2} ) \frac{{f}_{s}}{384} Hz \qquad [ 22 ]$$

where k=0 . . . 191, fₛ is the sampling frequency and the divisor 384 corresponds with the transform length N. Hence 192 frequencies are calculated from equation [22], one for each MDCT bin.

The respective MDCT coefficients, or frequency lines, produced by the hybrid filterbank are then processed, for example using the IMDCT unit 144, overlap-add unit 146 and MDST unit 148 shown in FIG. 3, to produce corresponding MDST coefficients. Hence, respective complex-valued coefficients are available for each sinusoidal signal. Because each sinusoid comprises only one respective frequency component, only two complex-valued coefficients are produced for each sinusoid: one representing the respective sinusoid itself (i.e. which corresponds in frequency and amplitude with the respective sinusoid), the other representing a mirror component that has arisen as a result of aliasing caused by the filterbank. If the amplitude of the sinusoid component is assumed to be A, then the amplitude of the mirror component is rA. Since A is known, r can easily be calculated. The weight q may be calculated in a similar manner. This process is repeated for each sinusoid to produce respective values for r and q for each set of mirroring frequency bands. It is noted from equations [21] and [22] that the respective values of r and q also vary according to window type. It is preferred to optimise the values for r and q as calculated above by using a conventional non-linear optimisation algorithm.

The invention is not limited to MPEG-1 layer III data signals or to MDCTs. In this connection, it is noted that the term “granule” is primarily an mp3 term but a skilled person will readily understand that, in the context of non-mp3 embodiments, the term “granule” as used herein may be interpreted as any equivalent grouping of frequency lines or coefficients (commonly the term “frame” is equivalent to “granule”).

By way of further example, FIG. 8 shows a block diagram of a decoder 240 for MPEG-1 layer I or layer II signals embodying a further aspect of the invention. By way of background, FIG. 7 shows a simplified block diagram of a conventional MPEG-1 layer I/II decoder comprising a component 130 for decoding spectral values contained in a received MPEG-1 layer I/II bitstream to produce 32 sub-band signals. The sub-band signals are then provided to a synthesis sub-band filterbank 136 which produces a corresponding time domain audio output signal x(n).

In FIG. 8, the decoder 240 includes a component or module 212 for decoding the spectral values contained in a received data signal, e.g. an MPEG-1 layer I/II bitstream, to produce a plurality of sub-band signals, or sub-band signal components. In the case where the received data signal comprises an MPEG-1 layer I/II bitstream, 32 sub-band signals are produced for each frame. The sub-band signals are provided to a synthesis sub-band filterbank 236 which produces a corresponding time domain signal x(n) comprising a plurality of data samples. In the case where the received data signal comprises an MPEG-1 layer I/II bitstream, the filterbank 236 comprises a 32 band cosine-modulated synthesis filterbank. The time domain signal x(n) is then provided to an analysis sub-band filterbank 237 which produces a plurality of sub-band signals, or signal components. In the case where the received data signal comprises an MPEG-1 layer I/II bitstream, the filterbank 237 comprises a 32 band filterbank and produces 32 sub-band signals for each frame. Further, the modulation of the analysis filterbank 237 is orthogonal to the modulation of the synthesis filterbank 236. Hence, in the case where the received data signal comprises an MPEG-1 layer I/II bitstream, the analysis filterbank 237 comprises a sine modulated filterbank. As a result, each sub-band signal produced by the analysis filterbank 237 may be used as the imaginary valued part of a complex-valued sub-band signal, the corresponding real-valued part being provided by the corresponding sub-band signal produced by the decoder 212.

The complex-valued sub-band signals lend themselves to being processed, or adjusted, before being converted to the time domain. Hence, the decoder 240 further includes a processing unit 256 for adjusting one or more of the complex-valued sub-band signals as desired. Since the complex-valued sub-band signals are frequency domain components, post-processing may advantageously be performed directly on one or more frequency components of the coded signal.

The complex-valued sub-band signals comprise complex exponential modulated sub-band coefficients and may be converted to the time domain using a complex exponential modulated synthesis filterbank 239 of which only the real-valued output components are required (shown as data signal x′(n) in FIG. 8).

Moreover, in general, the invention is not limited to embodiments described herein which may be modified or varied without departing from the scope of the invention.

1. A decoder comprising means for recovering a plurality of first spectral coefficients from a received signal, the first spectral coefficients comprising the products of first transform means; inverse transform means for transforming said first spectral coefficients into one or more time domain signal components; second transform means for transforming said one or more time domain signal components into a plurality of second spectral coefficients, wherein, the modulation of said second transform means is orthogonal to the modulation of said first transform means at corresponding modulation frequencies, the decoder further comprising means for processing one or more of said first spectral coefficients in conjunction with a respective second spectral coefficient.

2. A decoder as claimed in claim 1, wherein said recovering means comprises means for decoding and dequantizing a received data signal to recover first spectral coefficients, said first spectral coefficients comprising the products of a first frequency transform; wherein said inverse transform means comprises means for performing one or more inverse frequency transforms on said first spectral coefficients to produce said time domain signal components, wherein second transform means comprises means for performing one or more second forward frequency transforms on said time domain signal components to produce said second spectral coefficients, and wherein said first forward frequency transform is orthogonal to said second forward frequency transform at corresponding modulation frequencies.

3. A decoder as claimed in claim 2, wherein said first spectral coefficients comprise the output of a critically sampled forward frequency transform, said critically sampled forward frequency transform employing a 50% overlap in data samples to be transformed.

4. A decoder as claimed in claim 2, wherein one of said first forward frequency transform and said second forward frequency transform comprises the Modified Discrete Cosine Transform (MDCT), the other comprising the Modified Discrete Sine Transform (MDST).

5. A decoder as claimed in claim 4, wherein said first forward frequency transform comprises the Modified Discrete Cosine Transform (MDCT), said inverse frequency transform comprises the inverse Modified Discrete Cosine Transform (IMDCT) and said second forward frequency transform comprises the Modified Discrete Sine Transform (MDST).

6. A decoder as claimed in claim 2, wherein one or more windowing and overlap-add operations are performed on said time domain signal components before said one or more second forward frequency transforms.

7. A decoder as claimed in claim 6, further including means for delaying said first spectral coefficients so that each first spectral coefficient is synchronised with the respective corresponding second spectral coefficient.

8. A decoder as claimed in claim 2, further including means for introducing aliasing into said first spectral coefficients to produce aliased first spectral coefficients, said one or more inverse frequency transforms being performed on said aliased first spectral coefficients.

9. A decoder as claimed in claim 8, further including means for performing aliasing reduction on said second spectral coefficients.

10. A decoder as claimed in claim 8, further including means for performing complex-valued aliasing reduction on said second spectral coefficients and their respective aliased first spectral coefficients, wherein said complex-valued aliasing reduction means comprises one or more anti-aliasing butterflies arranged to apply complex-valued weights to said aliased first and corresponding second frequency components.

11. A decoder as claimed in claim 2, wherein each first spectral coefficient and respective second spectral coefficient together comprise a complex-valued spectral coefficient, the decoder further including means for performing one or more complex-valued inverse frequency transforms on said complex-valued spectral coefficients to produce a plurality of data samples; means for applying one or more types of window functions to said data samples to produce a plurality of windowed data samples; and means for constructing an output signal from said windowed data samples.

12. A decoder as claimed in claim 11, wherein a respective set of complex-valued spectral coefficients are produced for each granule of first spectral coefficients recovered from said received data signal, and wherein, in respect of at least a first type of window function, said complex-valued inverse frequency transform means is arranged to perform a single inverse frequency transform on all complex-valued spectral coefficients of a respective set.

13. A decoder as claimed in claim 11, wherein said output signal constructing means applies one or more overlap-add operations to said windowed data samples to produce said output signal.

14. A decoder as claimed in claim 11, wherein, in respect of at least said first type of window function, said window function application means is arranged to apply a single window function to all data samples produced in respect of a respective set of complex-valued spectral coefficients.

15. A decoder as claimed in claim 11, wherein said at least first type of window function includes length adjusted versions of MPEG-1 layer III type 0, type 1 and type 3 window functions.

16. A decoder as claimed in claim 11, wherein in respect of at least a second type of window function, said complex-valued inverse frequency transform means is arranged to perform a respective inverse frequency transform on a respective sub-set of complex-valued spectral coefficients, all of the complex-valued frequency components of a set belonging to one or other of said sub-sets.

17. A decoder as claimed in claim 16, wherein, in respect of at least said second type of window function, said window function application means is arranged to apply a single window function to all data samples produced in respect of a respective sub-set of complex-valued spectral coefficients.

18. A decoder as claimed in claim 16, wherein said at least second type of window function includes a length adjusted version of the MPEG-1 layer III type 2 window function, and the complex-valued spectral coefficients of each set belong to one or other of three respective sub-sets.

19. A decoder as claimed in claim 11, wherein a respective set of complex-valued spectral coefficients are associated with a respective frequency sub-band and wherein, in respect of at least a first type of window function, said complex-valued inverse frequency transform means is arranged to perform a respective inverse frequency transform on each set of complex-valued spectral coefficients and, in respect of at least a second type of window function, said complex-valued inverse frequency transform means is arranged to perform a respective inverse frequency transform on a respective sub-set of complex-valued spectral coefficients, all of the complex-valued frequency components of a set belonging to one or other of said sub-sets.

20. A decoder as claimed in claim 19, wherein said output signal constructing means comprises a complex exponential modulated synthesis filterbank, of which the real-valued output components comprise said output signal.

21. A decoder as claimed in claim 11, wherein said complex-valued inverse frequency transform comprises an odd-frequency modulated inverse Discrete Fourier Transform (DFT).

22. A decoder as claimed in claim 21, wherein said complex-valued inverse frequency transform comprises an odd-time odd-frequency modulated inverse Discrete Fourier Transform (O²DFT).

23. A decoder as claimed in claim 11, further including means for adjusting the phase of the complex-valued spectral coefficients in accordance with equations [5] and [6] of the accompanying description.

24. A decoder as claimed in claim 1, wherein said inverse transform means comprises a synthesis sub-band filterbank and second forward transform means comprises an analysis sub-band filterbank.

25. A decoder as claimed in claim 24, wherein said first transform means comprises an analysis filterbank, one of said first and second forward transform means being cosine modulated, the other being sine modulated.

26. A decoder as claimed in claim 24, further including a complex exponential modulated synthesis filterbank arranged to produce a time domain output signal from said first and second spectral coefficients.

27. A method of decoding a data signal, the method comprising recovering a plurality of first spectral coefficients from a received signal, the first spectral coefficients comprising the products of first transform means; transforming, by inverse transform means, said first spectral coefficients into one or more time domain signal components; transforming, by second transform means, said one or more time domain signal components into a plurality of second spectral coefficients, wherein the modulation of said second transform means is orthogonal to the modulation of said first transform means at corresponding modulation frequencies, the method further comprising processing one or more of said first spectral coefficients in conjunction with a respective second spectral coefficient.
